(19) United States
(12) Patent Application Publication
(10) Pub. No.: US 2025/0281338 A1
(43) Pub. Date: Sep. 11, 2025

(54) SAFETY MECHANISM FOR ACCESSIBLE LIFT EQUIPPED VEHICLES

(71) Applicant: James Corey Rust, Edmonds, WA (US)

(72) Inventor: James Corey Rust, Edmonds, WA (US)

(21) Appl. No.: 18/601,198

(22) Filed: Mar. 11, 2024

(51) Int. Cl. A61G 3/02

(52) U.S. Cl. CPC A61G 3/02

(57) ABSTRACT

Disclosed is a vehicle rack comprising a bed mount configured to be mounted on a vehicle bed, the bed mount comprising: a mounting plate including a first portion adjacent to an inner wall of the vehicle bed, a second portion adjacent to an outer wall of the vehicle bed, and a third portion connecting the first and second portions, at least two mounting shaft sleeves attached to the second portion of the mounting plate, and a receptacle configured to be detachably connected to the bed mount, the receptacle comprising: at least two mounting shafts, each configured to be inserted into a corresponding one of the at least two mounting shaft sleeves, a plurality of pairs of through holes in the mounting shafts, and at least one stop pin configured to be positioned within at least one pair of the plurality of pairs of through holes.

### CROSS-REFERENCE TO RELATED APPLICATION

This application claims the benefit of priority under 35 U.S.C. § 119 to U.S. Provisional Application No. 63/451,492, filed Mar. 10, 2023, in the United States Patent and Trademark Office, the entire contents of which is hereby incorporated by reference.

### FIELD OF THE INVENTION

This disclosure relates to an apparatus for accessible lift-equipped vehicles and, more particularly, to a safety mechanism for accessible lift-equipped vehicles.

### BACKGROUND

Vehicular wheelchair lifts are widely utilized to assist persons in wheelchairs to get into and out of vehicles (e.g., vans, shuttles, buses, etc.). These lifts typically have a moveable platform for transporting an occupied wheelchair, where the moveable platform can be raised and lowered between a position at a ground level outside a vehicle and a position at a floor level inside the vehicle. However, when moveable platform is at a ground level, a wheelchair at floor level within the vehicle may roll or be rolled out of the vehicle.

The disclosed embodiments have been provided to address these and other shortcomings.

### SUMMARY

In some exemplary embodiments, the disclosure is directed to a lift safety apparatus, comprising: a fixed plate configured to be removably attached within a vehicle; a lift plate adjacent to the fixed plate; and a hinge connecting the lift plate to the fixed plate, wherein the lift plate comprises first and second arms, and wherein each of the first and second arms comprises a first vertical arm portion, a second vertical arm portion, and a contact arm portion.

### BRIEF DECRIPTION OF THE DRAWINGS

The foregoing summary, as well as the following detailed description of example embodiments of this invention, will be better understood when read in conjunction with the appended drawings. In the drawings:

FIG. 1 is a plan view of a lift safety mechanism prior to fabrication, according to certain example embodiments;

FIG. 2 is a side view of an arm of the lift safety mechanism of FIG. 1, according to certain example embodiments;

FIG. 3 is a front view of an arm of the lift safety mechanism of FIG. 1, according to certain example embodiments;

FIG. 4 is an enlarged plan view of an arm of the lift safety mechanism of FIG. 1, according to certain example embodiments; and

FIG. 5 is a view illustrating attachment and operation of lift safety mechanism, according to certain example embodiments.

### DETAILED DESCRIPTION

The present disclosure now will be described more fully hereinafter with reference to the accompanying drawings, in which various embodiments are shown. The invention may, however, be embodied in many different forms and should not be construed as limited to the example embodiments set forth herein. These example embodiments are just that—examples—and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail—it is impracticable to list every possible variation for every feature described herein. The language of the claims should be referenced in determining the requirements of the invention.

In the drawings, the size and relative sizes of features and components may be exaggerated for clarity. Like reference characters refer to like elements throughout. Though the different figures show variations of exemplary embodiments, these figures are not necessarily intended to be mutually exclusive from each other. Rather, as will be seen from the context of the detailed description below, certain features depicted and described in different figures can be combined with other features from other figures to result in various embodiments, when taking the figures and their description as a whole into consideration. The terminology used herein is for the purpose of describing particular embodiments only and is not intended to be limiting of the invention.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, or as “contacting” or “in contact with” another element (or using any form of the word “contact”), there are no intervening elements present at the point of contact.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

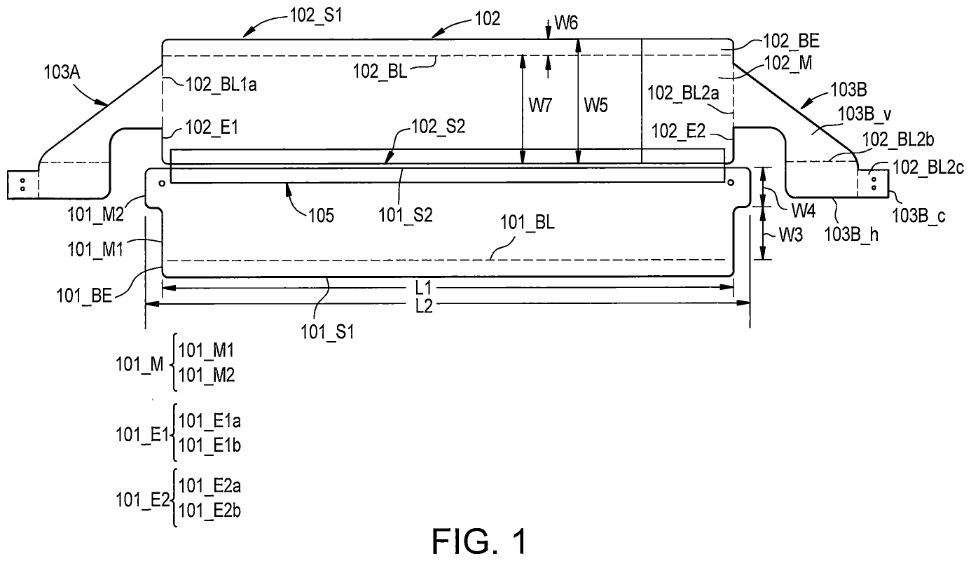

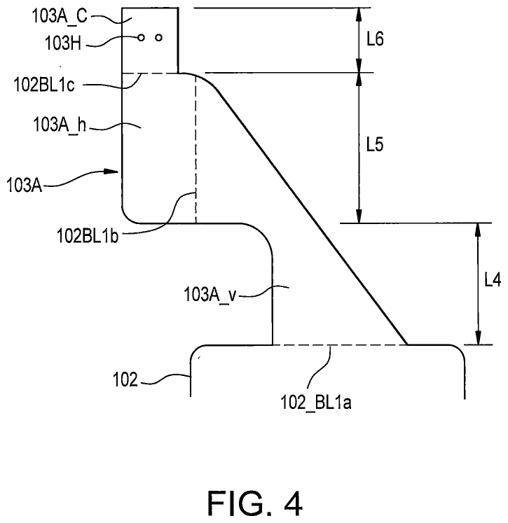

FIG. 1 is a plan view of a lift safety mechanism, according to certain example embodiments. FIG. 4 is an enlarged plan view of an arm of the lift safety mechanism of FIG. 1, according to certain example embodiments. FIGS. 1 and 4 are plan views of the lift safety mechanism prior to fabrication (e.g., before the lift plate is bent along the dashed lines in accordance with the bend lines or bend profiles).

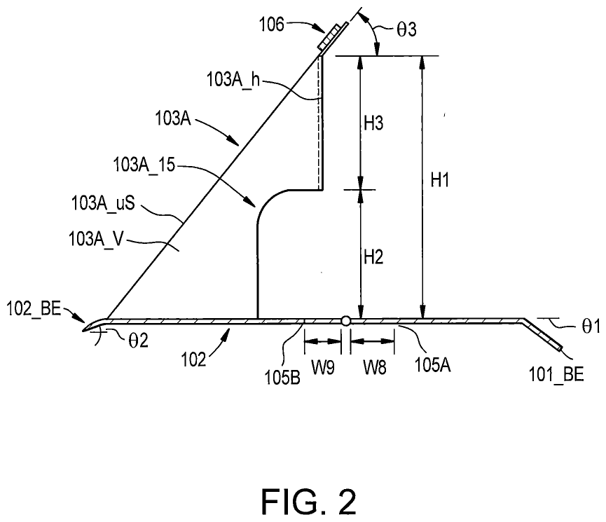

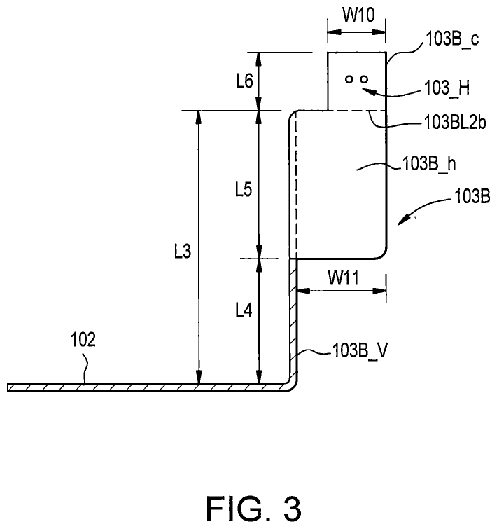

FIG. 2 is a side view of an arm of the lift safety mechanism of FIG. 1, according to certain example embodiments. FIG. 3 is a front view of an arm of the lift safety mechanism of FIG. 1, according to certain example embodiments. FIGS. 2 and 3 illustrate an arm of the lift safety mechanism after fabrication (e.g., after the lift plate is bent along the dashed lines in accordance with the bend lines or bend profiles).

Referring to FIGS. 1, 2, 3, and 4, the lift safety mechanism 100 may be comprised of at least two plate portions. For example, the lift safety mechanism 100 may include a fixed plate 101 and a lift plate 102. In example embodiments, each of the fixed plate 101 and the lift plate 102 may be formed of a single piece of rigid material (e.g., a metal) that can be bent, as discussed further below. The rigid material forming each of the fixed plate 101 and the lift plate 102 may be steel, such as, for example, an 11-gauge steel plate. However, those of ordinary skill in the art will appreciate from this disclosure that any suitable material, such as allow, aluminum, composite, or the like, may be used without departing from the scope of the present invention. For example, the aforementioned lift safety mechanism 100 may be constructed of other gauges of steel, carbon fiber, plastic polymer matrices, or other materials.

The fixed plate 101 may include a first side 101_S1 and a second side 101_S2 opposite the first side 101_S1. The first side 101_S1 and the second side 101_S2 may extend lengthwise in parallel with one another. The fixed plate 101 may include a first end 101_E1 and a second end 101_E2 opposite the first end 101_E1. The first end 101_E1 and the second end 101_E2 may connect the first side 101_S1 and the second side 101_S2 of the fixed plate 101. The first end 101_E1 and the second end 101_E2 may mirror one another. For example, a shape of the first end 101_E1 may mirror a shape of the second end 101_E2.

The first end 101_E1 may include a first first end surface 101_E1a, a second first end surface 101_E1b, and a connecting first end surface 101_E1c. The first first end surface 101_E1a may be substantially perpendicular to the first side 101_S1, and the second first end surface 101_E1b may be substantially perpendicular to the second side 101_S2. The connecting first end surface 101_E1c may be directly connected to each of the first first end surface 101_E1a and the second first end surface 101_E1b. In example embodiments, the connecting first end surface 101_E1c may be substantially parallel to each of the first side 101_S1 and the second side 101_S2, but embodiments are not limited thereto. For example, the connecting first end surface 101_E1cmay be at an angle with respect to the first side 101_S1 and the second side 101_S2. For example, the connecting first end surface 101_E1c may not be perpendicular to either of the first first end surface 101_E1a or the second first end surface 101_E1b.

The second end 101_E2 may include a first second end surface 101_E2a, a second second end surface 101_E2b, and a connecting second end surface 101_E2c. The first second end surface 101_E2a may be substantially perpendicular to the first side 101_S1, and the second second end surface 101_E2b may be substantially perpendicular to the second side 101_S2. The connecting second end surface 101_E2c may be directly connected to each of the first second end surface 101_E2a and the second second end surface 101_E2b. In example embodiments, the connecting second end surface 101_E2c may be substantially parallel to each of the first side 101_S1 and the second side 101_S2, but embodiments are not limited thereto. For example, the connecting second end surface 101_E2c may be at an angle with respect to the first side 101_S1 and the second side 101_S2. For example, the connecting second end surface 101_E2c may not be perpendicular to either of the first second end surface 101_E2a or the second second end surface 101_E2b.

The fixed plate 101 may further include a main portion 101_M between the second side 101_S2 and the bend line 101_BL, and a beveled edge 101_BE between the bend line 101_BL and the first side 101_S1. The beveled edge 101_BE may have a first width W1 between the bend line 101_BL and the first side 101_S1. The first width W1 of the beveled edge 101_BE may be in the range of about 0.5-1.5 inches. In example embodiments, the first width W1 of the beveled edge 101_BE may be about ¾ inches.

The beveled edge 101_BE may be formed by bending the fixed plate 101 at the bend line 101_BL. For example, the fixed plate 101 may be bent at the bend line 101_BL to form the beveled edge 101_BE. Referring to FIG. 2, the beveled edge 101_BE may form an angle θ1 with respect to the main portion 101_M of the fixed plate 101. In example embodiments, the angle θ1 may be in the range of about 30° to about 60°. In some embodiments, the angle θ1 may be in the range of about 40° to about 50°. In certain embodiments, the angle θ2 may be about 45°. The beveled edge 101_BE may function to allow a wheeled device, such as a wheelchair or stretcher, to roll smoothly onto and over the fixed plate 101.

The main portion 101_M may have a first length L1 between the first first end surface 101_E1a and the first second end surface 101_E2a, and a second length L2 between the first second end surface 101_E1b and the second second end surface 101_E2b. The first length L1 may be less than the second length L2. The second length L2 may be in the range of about 1-3 inches larger than the first length L1. The first length L1 may be in a range of about 34-39 inches, and the second length L2 may be in a range of about 35-42 inches. In some embodiments, the first length L1 may be in a range of about 35-36 inches, and the second length L2 may be in a range of about 37-38 inches. For example, the first length L1 be about 35⅛ inches, and the second length L2 may be about 37¼ inches. As another example, the first length L1 may be about 38⅛ inches, and the second length L2 may be about 40¼ inches.

The main portion 101_M of the fixed plate 101 may have a second width W2, which is the width of the fixed plate 101 from the bend line 101_BL to the second side 101_S2 of the fixed plate 101. The main portion 101_M may include a first main portion 101_M1 and a second main portion 101_M2. The first main portion 101_M1 may be adjacent to the beveled edge 101_BE and may have the third width W3, which is the width between the bend line 101_BL and the transition from the first length L1 to the second length L2. The second main portion 101_M2 may be adjacent to the second side 101_S2 of the fixed plate 101. The second main portion 101_M2 may have a fourth width W4, which is the width between second side 101_S2 of the fixed plate 101 and the transition from the first length L1 to the second length L2. The second width W2 may be equal to the sum of the third width W3 and the fourth width W4. The second main portion 101_M2 may have the second length L2, and the first main portion 101_M1 may have the first length L1, which is smaller than the second length L2. In some embodiments, the connecting first end surface 101_E1c and the connecting second end surface 101_E2c may define the transition from the first length L1 to the second length L2.

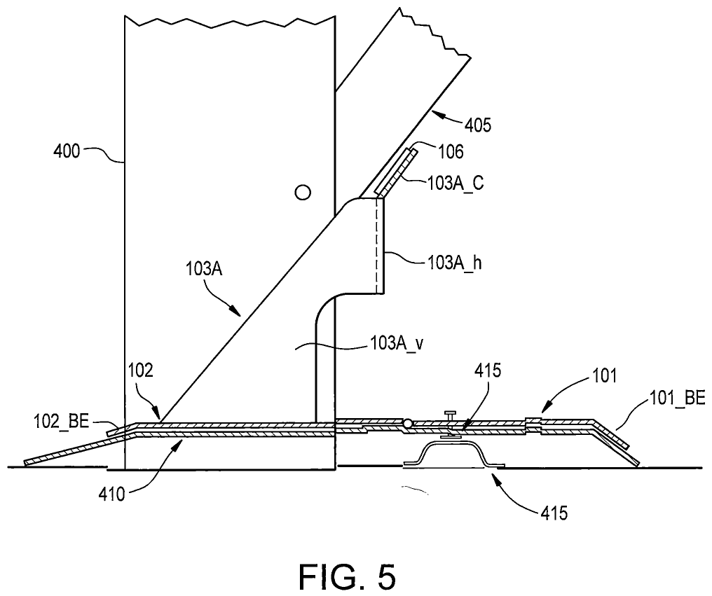

As discussed further below in connection with FIG. 5, the fixed plate 101 may straddle or conform to components of a lift mechanism installed in a transportation vehicle. In example embodiments, the fixed plate may be disposed between arms of a lift mechanism previously installed on the transportation vehicle and/or on a lift pressure plate provided on a floor of the transportation vehicle. For example, the fixed plate 101 may be provided on top of or over an existing pressure plate of the transportation vehicle. The fixed plate 101 may lay substantially parallel to the floor of the transportation vehicle. The fixed plate 101 may be affixed to the transportation vehicle using pressure plate fasteners extending inserted through holes 101_H in the fixed plate 101.

FIG. 1 illustrates a single hole 101_H adjacent to a first end of the fixed plate 101, and a single hole 101_H adjacent to a second end 101_E2 of the fixed plate 101. However, embodiments are not limited thereto, and there may a plurality of holes 101_H adjacent to each of the first end 101_E1 and a second end 101_E2 of the fixed plate 101. The holes 101_H may be in the range of ¼ to ¾ inches in diameter. In some embodiments, each hole 101_H may be about ⅜ inches in diameter. The pressure plate fasteners may be, for example, bolts, rods, screws, etc.

In some embodiments, the intersection of the first side 101_S1 and the first end 101_E1 may be rounded, and the intersection of the first side 101_S1 and the second end 101_E2 may be rounded. For example, the intersection of the first side 101_S1 and the first end 101_E1 and the intersection of the first side 101_S1 and the second end 101_E2 each may be rounded corners having a radius of about 1 inch. However, embodiments are not limited thereto. In some embodiments, the first side 101_S1 and the first end 101_E1 may form a right angle with one another, and the first side 101_S1 and the second end 101_E2 may form a right angle with one another.

In some embodiments, the intersection of the second side 101_S2 and the first end 101_E1 may be rounded, and the intersection of the second side 101_S2 and the second end 101_E2 may be rounded. For example, the intersection of the second side 101_S2 and the first end 101_E1 and the intersection of the second side 101_S2 and the second end 101_E2 each may be a rounded corner having a radius of about 1 inch. However, embodiments are not limited thereto. In some embodiments, the second side 101_S2 and the first end 101_E1 may form a right angle with one another, and the second side 101_S2 and the second end 101_E2 may form a right angle with one another.

In some embodiments, the intersection of the connecting first end surface 101_E1c and the first first end surface 101_E1a may be rounded, and the intersection of the connecting first end surface 101_E1c and the second first end surface 101_E1b may be rounded. For example, the intersection of the connecting first end surface 101_E1c and the first first end surface 101_E1a and the intersection of the connecting first end surface 101_E1c and the second first end surface 101_E1b each may be a rounded corner having a radius of about 1 inch. However, embodiments are not limited thereto. In some embodiments, the intersection of the connecting first end surface 101_E1c and the first first end surface 101_E1a may form a right angle, and the intersection of the connecting first end surface 101_E1c and the second first end surface 101_E1b may form a right angle.

In some embodiments, the intersection of the connecting second end surface 101_E2cand the first second end surface 101_E2a may be rounded, and the intersection of the connecting second end surface 101_E2c and the second second end surface 101_E2b may be rounded. For example, the intersection of the connecting second end surface 101 E2c and the first second end surface 101_E2a and the intersection of the connecting second end surface 101_E2c and the second second end surface 101_E2b each may be a rounded corner having a radius of about 1 inch. However, embodiments are not limited thereto. In some embodiments, the intersection of the connecting second end surface 101_E2c and the first second end surface 101_E2a may form a right angle, and the intersection of the connecting second end surface 101_E2c and the second second end surface 101_E2b may form a right angle.

The lift plate 102 may include a first side 102_S1 and a second side 102_S2 opposite the first side 102_S1. The first side 102_S1 and the second side 102_S2 may extend lengthwise in parallel with one another. The lift plate 102 may include a first end 102_E1 and a second end 102_E2 opposite the first end 102_E1. The lift plate 102 may have a fifth width W5 between the first side 102_S1 and the second side 102_S2. The fifth width W5 may be in a range of about 5 to 9 inches. In example embodiments, the fifth width W5 may be in a range of about 6 to 8 inches. In some embodiments, the fifth width W5 may be about 7 inches

The lift plate 102 may further include a main portion 102_M between the second side 102_S2 and the bend line 102_BL, and a beveled edge 102_BE between the bend line 102_BL and the first side 102_S1. The beveled edge 101_BE may have a sixth width W6 between the bend line 102_BL and the first side 102_S1. The sixth width W6 of the beveled edge 102_BE may be in the range of about 0.5-1.5 inches. In example embodiments, the sixth width W6 of the beveled edge 102_BE may be about ⅝ inches.

The beveled edge 102_BE may be formed by bending the lift plate 102 at the bend line 102_BL. For example, the lift plate 102 may be bent at the bend line 102_BL to form the beveled edge 102_BE. Referring to FIG. 2, the beveled edge 102_BE may form an angle θ2 with respect to the main portion 102_M of the lift plate 102. In example embodiments, the angle θ2 may be in the range of about 5° to about 30°. In some embodiments, the angle θ2 may be in the range of about 8° to about 12°. In certain embodiments, the angle θ2 may be about 10°.

The main portion 102_M may have a seventh width W7 between the first side 102_S1 and the bend line 102_BL2. The seventh width W7 may be in a range of about 5 to 8 inches. In example embodiments, the seventh width W7 may be in a range of about 6 to 7 inches. In some embodiments, the seventh width W7 may be about 6⅜ inches. The fifth width W5 may be equal to the sum of the sixth width W6 and the seventh width W7. The main portion 102_M and the beveled edge 102_BE each may have the first length L1 between the first end 102_E1 and the second end 102_E.

The lift plate 102 may be connected to the fixed plate 101 by a hinge 105. In example embodiments, the hinge 105 may be a single hinge that extends more than about 50% of the first length L1. For example, the single hinge 105 may extend more than about 75% of the first length L1. More specifically, the single hinge 105 may extend more than about 90% of the first length L1. In other example embodiments, the hinge 105 may be a plurality of hinges that extend more than about 50% of the first length L1. For example, the plurality of hinges 105 may extend more than about 75% of the first length L1. More specifically, the plurality of hinges 105 may extend more than about 80% of the first length L1.

The hinge 105 may have a first part 105A that overlaps the fixed plate 101 and a second part 105B that overlaps the lift plate 102. The first part 105A may have an eighth width W8, and the second part 105B may have a ninth width W9. Each of eighth width W8 and the ninth width W9 may be in a range of about ½ to 2 inches. In example embodiments, each of eighth width W8 and the ninth width W9 may be about 1 inch.

The first part 105A may be attached to an underside of the fixed plate 101, and the second part 105B may be attached to an underside of the lift plate 102. For example, the first part 105A may be attached to the underside of the fixed plate 101 by rivets extending through the first part 105A and the fixed plate 101, and the second part 105B may be attached to an underside of the lift plate 102 by rivets extending through the first part 105A and the lift plate 102. Alternatively and/or additionally, the first part 105A may be attached to the underside of the fixed plate 101 by welding the first part 105A to the fixed plate 101, and the second part 105B may be attached to an underside of the lift plate 102 by welding the first part 105A to the lift plate 102. However, embodiments are not limited thereto, and the first part 105A and the second part 105B may be attached to the fixed plate 101 and the second part 105B by any suitable mechanism.

The lift plate 102 may further include a first lift arm 103A at the first end 102_E1 of the lift plate 102, and a second lift arm 103B at the second end 102_E2 of the lift plate 102. For example, the lift plate 102 may be bent at the first arm bend line 102_BL1a to form the first arm 103A, and the lift plate 102 may be bent at the second arm bend line 102_BL2a to form the second arm 103B. The first arm 103A may form a right angle with respect to the main portion 102_M of the lift plate 102 at the first arm bend line 102_BL1a, and the second arm 103B may form a right angle with respect to the main portion 102_M of the lift plate 102 at the second arm bend line 102_BL2a. Each of the first arm bend line 102_BL1a and the second arm bend line 102_BL2a may be in the range of about 3 to 5 inches. In example embodiments, each of the first arm bend line 102_BL1a and the second arm bend line 102_BL2a may be about 4 inches. The first arm 103A and the second arm 103B may mirror one another.

The first arm 103A may include a first vertical arm portion 103A_v, a first connecting arm portion 103A_h, and a first contact arm portion 103A_c. The first connecting arm portion 103A_h may form a right angle with respect to the first vertical arm portion 103A_v at a third bend line 102_BL1b. The first contact arm portion 103A_c may form an angle θ3 with respect to the first connecting arm portion 103A_h at a fourth bend line 102_BL1c. The angle θ3 may be in a range of about 40° to about 60°. In some embodiments, the angle θ3 may be in the range of about 45° to about 55°. In certain embodiments, the angle θ3 may be about 50°. The third bend line 102_BL1b may be in a range of about 3 to 6 inches. In example embodiments, the third bend line 102_BL1b may be in a range of about 4 to 5 inches. In some embodiments, the third bend line 102_BL1b may be about 4⅛ inches. The fourth bend line 102_BL1c may be in a range of about 1 to 3 inches. In example embodiments, the fourth bend line 102_BL1c may be in a range of about 1 to 2 inches. In some embodiments, the fourth bend line 102_BL1c may be about 1½ inches.

The second arm 103B may include a second vertical arm portion 103B_v, a second connecting arm portion 103B_h, and a second contact arm portion 103B_c. The second connecting arm portion 103B_h may form a right angle with respect to the second vertical arm portion 103B_v at a fifth bend line 102_BL2b. The second contact arm portion 103B_c may form an angle θ3 with respect to the second connecting arm portion 103B_h at a sixth bend line 102_BL2c. The angle θ3 may be in a range of about 40° to about 60°. In some embodiments, the angle θ3 may be in the range of about 45° to about 55°. In certain embodiments, the angle θ3 may be about 50°. The fifth bend line 102_BL2b may be in a range of about 3 to 6 inches. In example embodiments, the fifth bend line 102_BL2b may be in a range of about 4 to 5 inches. In some embodiments, the fifth bend line 102_BL2b may be about 4⅛ inches. The sixth bend line 102_BL2c may be in a range of about 1 to 3 inches. In example embodiments, the sixth bend line 102_BL2c may be in a range of about 1 to 2 inches. In some embodiments, the sixth bend line 102_BL2c may be about 1½ inches.

Each of the first vertical arm portion 103A_v and the second vertical arm portion 103B_v may have a third length L3 in the range of about 6 to 8 inches. In some embodiments, each of the first arm 103A and the second arm 103B may have a third length L3 of about 7¼ inches.

When bent at the first arm bend line 102_BL1b and the second arm bend line 102_BL2b, respectively, each of the first connecting arm portion 103A_h and the second connecting arm portion 103B_h may be perpendicular to the upper surface of the lift plate 102. Bottom surfaces of each of the first connecting arm portion 103A_h and the second connecting arm portion 103B_h may be spaced apart from the lift plate 102 by a fourth length L4. The fourth length L4 may be in the range of about 2 to 5 inches. In some embodiments, the fourth length L4 may be in the range of about 3 to 4 inches. For example, the fourth length L4 may be about 3⅛ inches. Each of the first connecting arm portion 103A_h and the second connecting arm portion 103B_h may have a fifth length L5. The fifth length L5 may be in the range of about 3 to 6 inches. In some embodiments, the fifth length L5 may be in the range of about 4 to 5 inches. For example, the fifth length L5 may be about 4⅛ inches. The third length L3 may be equal to the sum of the fourth length L4 and the fifth length L5.

Each of the first connecting arm portion 103A_h and the second connecting arm portion 103B_h may have an eleventh width W11 in the range of about 1 to 4 inches. In some embodiments, the eleventh width W11 may be in the range of about 2 to 3 inches. In example embodiments, the eleventh width W11 may be about 2½ inches. A bottom surface of the first connecting arm portion 103A_h may be spaced apart from the lift plate 102 by a fourth length L4.

When bent at the first arm bend line 102_BL1a and the second arm bend line 102_BL, respectively, each of the first arm 103A and the second arm 103B may have a first height H1 with respect to the lift plate 102 in a range of about 6 to 8 inches. In some embodiments, each of the first arm 103A and the second arm 103B may have a first height H1 with respect to the lift plate 102 of about 7¼ inches. In an example embodiment, each of the first vertical arm portion 103A_v and the second vertical arm portion 103B_v may have an upper linear surface, which extends from the lift plate 102 to the first contact arm portion 103A_c and second contact arm portion 103B_c, respectively. In addition, each of the first vertical arm portion 103A_v and the second vertical arm portion 103B_v may have a lower surface, which extends from the lift plate 102 to the first contact arm portion 103A_c and the second contact arm portion 103B_c, respectively. The lower surface may have a linear segment and a curvilinear segment. The first height H1 may be a sum of a second height H2, which is a height from the lift plate 102 to the intersection of the linear segment and the curvilinear segment, and a third height H3, which is a height form the intersection of the linear segment and the curvilinear segment to the first contact arm portion 103A_c and second contact arm portion 103B_c, respectively. The second height H2 may be in a range of about 1 to 5 inches. In example embodiments, the second height H2 may be in a range of about 3 to 4 inches. In some embodiments, the second height H2 may be about 3⅛ inches. The third height H3 may be in a range of about 2 to 6 inches. In example embodiments, the third height H3 may be in a range of about 3 to 5 inches. In some embodiments, the third height H3 may be about 4⅛ inches.

In example embodiments, each of the first contact arm portion 103A_c and second contact arm portion 103B_c may have a sixth length L6 in the range of about 1 to 4 inches. In some embodiments, each of the first contact arm portion 103A_c and second contact arm portion 103B_c may have a sixth length L6 in the range of about 1 to 3 inches. In example embodiments, each of the first contact arm portion 103A_c and second contact arm portion 103B_c may have a sixth length L6 of about 1½ inches. Each of the first contact arm portion 103A_c and second contact arm portion 103B_c may have a tenth width W10 in the range of about 1 to 4 inches. In some embodiments, each of the first contact arm portion 103A_c and second contact arm portion 103B_c may have a tenth width W10 in the range of about 1 to 3 inches. In example embodiments, each of the first contact arm portion 103A_c and second contact arm portion 103B_c may have a tenth width W10 of about 1½ inches. Although the first contact arm portion 103A_c and second contact arm portion 103B_c are illustrated as having a substantially square shape, embodiments are not limited thereto. Each of the first contact arm portion 103A_c and second contact arm portion 103B_c may have any polygonal shape (e.g., rectangular, triangular, etc.), rounded shape, circular shape, etc.

In example embodiments, each of the first contact arm portion 103A_c and second contact arm portion 103B_c may have one or more holes 103 H. The one or more holes 103 H may be configured to retain a fastener that holds a pad 106 against each of the first contact arm portion 103A_c and the second contact arm portion 103B_c. The fastener may include bolts, rods, screws, etc. The pad 106 may be comprised or rubber, plastic, or the like, and may allow for the arms of an existing lift previously installed on the transportation vehicle to slide along the first contact arm portion 103A_c and the second contact arm portion 103B_c.

FIG. 5 is a view illustrating attachment and operation of lift safety mechanism, according to certain example embodiments. Detailed here is the relationship between the lift plate 102, fixed plate 101, and the first and second arms 103A and 103B with respect to the existing accessible lift mechanism 400 and the pressure plate 410. As seen, the lift plate 102 and fixed plate 101 sit above the existing pressure plate 410 with the first and second arms 103A and 103B nested beneath respective lift arms 405 of the existing accessible lift mechanism 400. The fixed plate 101 may be fastened to the vehicle using the original pressure plate fastener 415 inserted through the ⅜″ hole in the fixed plate 101 with a rubber washer inserted beneath the existing pressure plate 410 and the steel channel below. As illustrated in FIG. 5, the pressure plate 410 may be mounted on the floor 415 of the transportation vehicle.

Each of the first lift arm 103A and the second lift arm 103B may nest beneath respective arms of an existing lift previously installed on the transportation vehicle. Each of the first contact arm portion 103A_c and second contact arm portion 103B_c may be configured to be in contact with the respective lift arms 405 of the existing lift 400, such that when the lift arms 405 of the existing lift 400 extend to lower the floor of the existing lift 400, the lift arms 405 of the existing lift 400 may press against the first contact arm portion 103A_c and the second contact arm portion 103B_c to cause the lift plate 102 to rise up away from the floor of the vehicle. For example, in operation, the lift arms 405 of the existing accessible lift mechanism 400 may extend forward and lower such that the lift arms 405 press against the first contact arm portion 103A_c and the second contact arm portion 103B_c, respectively. As the lift arms 405 press against the first contact arm portion 103A_c and the second contact arm portion 103B_c, respectively, the first and second arms 103A and 103B may cause the lift plate 102 to rise up. For example, and angle between the upper surface of the lift plate 102 and the upper surface of the fixed plate 101 may decrease as the first and second arms 103A and 103B may cause the lift plate 102 to rotate with respect to the hinge 105. For example, the lift plate 102 may be raised to create an angle between the floor of the vehicle and the lift plate 102, thereby preventing a wheelchair or the like from rolling beyond the lift plate 102. For example, when in a raised position, the lift plate 102 may form a barrier to stop a wheelchair from rolling out of the transportation vehicle.

The invention is used in a transportation vehicle (e.g., vans, shuttles, buses) equipped with an accessible lift used to raise and lower wheelchairs/stretchers/individuals into and out of such vehicles. The mechanism is intended to prevent wheelchairs from rolling or being rolled out of the vehicle while the lift is deployed to its lowest position. As the lift is deployed, the safety plate raises to create a barrier preventing wheelchairs from rolling out of the vehicle.

While the disclosed embodiments describe the invention in connection with transportation vehicles, such as vans, shuttles, and buses, the disclosed embodiments may be configured for use in any other location in which a wheelchair lift may be employed.

What is claimed is:

1. A lift safety apparatus, comprising:
a fixed plate configured to be removably attached within a vehicle;
a lift plate adjacent to the fixed plate; and
a hinge connecting the lift plate to the fixed plate,
wherein the lift plate comprises first and second arms, and
wherein each of the first and second arms comprises a first vertical arm portion, a second vertical arm portion, and a contact arm portion.
